(19) United States
(12) Patent Application Publication
(10) Pub. No.: US 2024/0083050 A1
(43) Pub. Date: Mar. 14, 2024

(54) SHAVING SYSTEM

(71) Applicant: BIC Violex Single Member S.A., Anoixi (GR)

(72) Inventor: Ion-Ioannis ANTONAKIS, Anoixi (GR)

(73) Assignee: BIC Violex Single Member S.A., Anoixi (FR)

(21) Appl. No.: 18/466,120

(22) Filed: Sep. 13, 2023

(30) Foreign Application Priority Data
Sep. 13, 2022 (EP) 22195326.8

(51) Int. Cl. B26B 21/40; A45D 27/00; B26B 21/52; B26B 21/56

(52) U.S. Cl. CPC B26B 21/4056; A45D 27/00; B26B 21/4081; B26B 21/526; B26B 21/565

(57) ABSTRACT

According to a first aspect, a razor head is provided. The razor head comprises one or more cutting members, one or more resilient elements, wherein a resilient element of the one or more resilient elements is connected with a respective cutting member from the one or more cutting members and wherein at least one resilient element of the one or more resilient elements is configured to transduce vibrations from the respective cutting member of the one or more cutting members into an electrical signal corresponding to the vibrations when the razor head is used by a user.

### CROSS REFERENCE TO RELATED APPLICATION

This application claims priority from European patent application EP22195326.8, filed on 13 Sep. 2022, its contents being incorporated herein by reference.

### TECHNICAL FIELD

The present disclosure relates to the field of razors, more specifically to a razor head, a shaving razor assembly comprising a razor head, and a kit of parts comprising a plurality of razor heads. The present disclosure is also related to a computer-implemented method for generating user feedback while using shaving razor assembly.

### BACKGROUND

Razor heads (also known as safety razor heads, razor cartridges or safety razor cartridges) are usually a part of a shaving razor assembly that includes a razor handle. A razor head typically comprises one or more cutting members, each including a blade, and being arranged between a leading longitudinal side and a trailing longitudinal side of the razor head. In use, a user holds the razor handle in a shaving direction and brings the razor head into contact with a portion of skin. By movement of the razor head in a shaving direction, unwanted hair is removed.

For most, using a razor is a daily process. At the same time, the focus of current developments is on the modification of everyday objects of use regarding the user experience such as acoustic, visual, or tactile feedback. This is also reflected in the autonomous sensory meridian response (ASRM) trend, which records strong growth rates. This is the perception of a tingling, pleasant feeling on the skin, which is associated with well-being, calming and relaxation in many persons. Autonomous sensory meridian response is triggered, for example, by certain sounds, soothing hand movements, or slight touch to the head.

In recent years, devices have been developed to create haptic and tactile stimuli that allow their integration into portable devices and wearables. Through these developments, seemingly simple objects can open up a new dimension of perception for the user. The use of previous razors, on the other hand, is a more or less eventless and dull everyday task.

For this reason, there is a need to improve razors as everyday objects in terms of haptic, visual, acoustic or tactile perception.

### SUMMARY

According to a first aspect, a razor head is provided. The razor head comprises one or more cutting members, one or more resilient elements, wherein a resilient element of the one or more resilient elements is connected with a respective cutting member from the one or more cutting members and wherein at least one resilient element of the one or more resilient elements is configured to transduce vibrations from the respective cutting member of the one or more cutting members into an electrical signal corresponding to the vibrations when the razor head is used by a user.

According to a second aspect, a shaving razor assembly is provided. The shaving razor assembly comprises the razor head, a razor handle, wherein the razor head is either releasably attached to the razor handle or integrally formed with the razor handle.

According to a third aspect, a kit of parts is provided. The kit of parts comprises a razor head holder comprising a plurality of the razor heads, a razor handle, and a charging system configured to charge an energy storage of the razor handle in accordance with the techniques of the second aspect, or its embodiments. The razor head holder of the third aspect comprises a plurality of razor heads in accordance with the techniques of the first aspect, or its embodiments.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different figures indicate like or similar features.

FIG. 1 schematically illustrates an example of a razor head comprising the resilient elements in a cross-sectional view along a transversal axis.

FIG. 2 schematically illustrates a cross-section of an example of a razor head comprising the cutting members with blades along a transversal axis.

FIG. 3 schematically illustrates an example of a shaving razor assembly comprising a razor head and a razor handle.

FIG. 4 schematically illustrates a cross-section of a blade support and two opposite resilient elements along a longitudinal axis.

FIG. 5 schematically illustrates a perspective partial exploded view of a razor head.

FIG. 6 schematically illustrates a functional interconnection of the shaving razor assembly components.

FIG. 7 schematically illustrates a computer-implemented method for generating user feedback while shaving using a shaving razor assembly.

### DETAILED DESCRIPTION

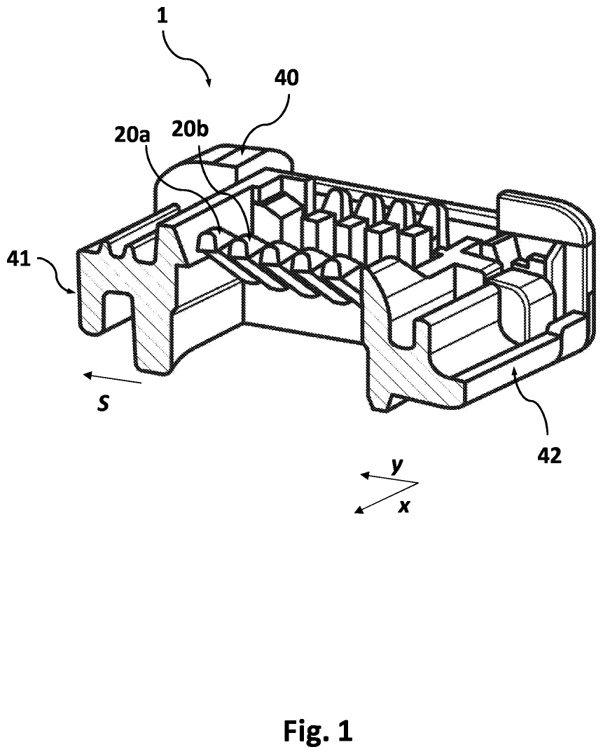

FIG. 1 schematically illustrates an example of a razor head comprising the resilient elements in a cross-sectional view along the transversal axis y.

According to the first aspect, the razor head 1 comprises one or more cutting members 10a, 10b, one or more resilient elements 20a, 20b, wherein the resilient element of the one or more resilient elements 20a, 20b is connected with a respective cutting member from the one or more cutting members 10a, 10b and wherein at least one resilient element of the one or more resilient elements 20a, 20b is configured to transduce vibrations from the respective cutting member of the one or more cutting members 10a, 10b into an electrical signal corresponding to the vibrations when the razor head 1 is used by the user. The transversal direction y is perpendicular to the longitudinal direction x and is substantially parallel to a shaving direction S. In the embodiment exemplified in FIG. 1, the cutting members 10a, 10b are disposed in a recess between a leading 41 longitudinal side and a trailing longitudinal side 42 of a housing 40 of the razor head 1.

In an example, the razor head 1 may extend longitudinally along the longitudinal axis x and the resilient element may be disposed on a first side of the longitudinal extension along the longitudinal axis x of the razor head 1 and may extend from the first side towards the respective cutting member from the one or more cutting members 10a, 10b along a first direction d, wherein the longitudinal axis x forms a predetermined angle with respect to the first direction d. The predetermined angle between the longitudinal axis x and the first direction d may be between 0° and 90° or close to 45°.

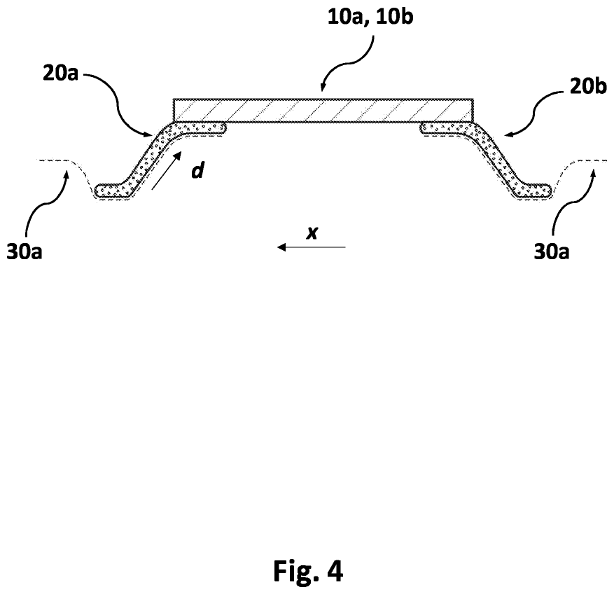

FIG. 4 schematically illustrates a cross-section of a blade support and two opposite resilient elements along the longitudinal axis x.

In an embodiment, the number of resilient elements of the one or more resilient elements (20a, 20b) is at least two, and wherein a second resilient element (20b) of the one or more resilient elements 20a, 20b is disposed on a second side of the longitudinal extension along the longitudinal axis x of the razor head 1 that is opposite the first side. In an example, the number of resilient elements of the one or more resilient elements 20a, 20b corresponds to the number of cutting members of the one or more cutting members 10a, 10b. In an example, the number of the one or more cutting members 10a, 10b may be one, two, three, four, five, six, seven, eight or more cutting members. In an example, the number of the resilient elements of the one or more resilient elements 20a, 20b is twice the number of cutting members of the one or more cutting members 20a, 20b. The razor head of the exemplary embodiment of FIG. 1 comprises five resilient elements on the first side of the longitudinal extension of the razor head 1. In an example, additionally to the five resilient elements 20a on the first side (as shown in FIG. 4) there may be disposed five second resilient elements 20b (as shown in FIG. 4) on the second side of the longitudinal extension along the longitudinal axis x of the razor head 1 opposite the five resilient elements 20a on the first side. In an example, additional or alternatively, a resilient element of the one or more resilient elements 20a, 20b may be disposed in a middle of the longitudinal extension along the longitudinal axis x of the razor head 1. In an example, the resilient element of the one or more resilient elements (20a, 20b) may be one of a spring, a beam, and a slab. In an example, the resilient element of the one or more resilient elements 20a, 20b may exert a bias force against the respective cutting member to which the resilient element is connected in the direction of the shaving plane SP, such that the resilient element of the one or more resilient elements 20a, 20b may serve as a damper and may allow the respective cutting member of the one or more cutting members 10a, 10b to conform to the skin topology of the user.

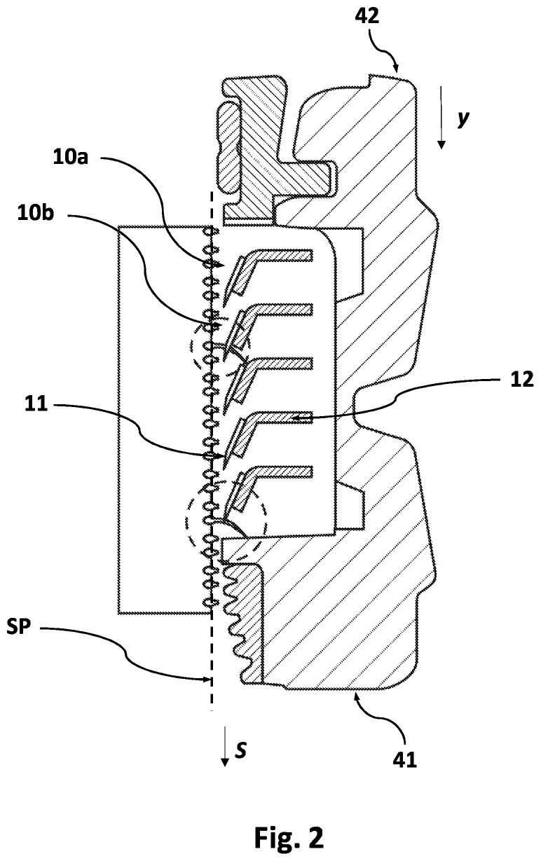

In an example, the cutting member of the one or more cutting members (10a, 10b) may be an integrally formed cutting member comprising a radiused bend, and a cutting edge formed at a distal end of the radiused bend, or wherein the cutting member of the one or more cutting members (10a, 10b) may comprise a blade attached to a blade support 12 of the cutting member. In some cases, as exemplary shown in FIG. 2, the cutting member may comprise a blade support 12 having a blade mounting portion disposed on an inner surface or on an outer surface of the blade support, wherein the blade 11 can be attached to the blade mounting portion. For example, the razor blade 11 may be glued, or laser welded to the blade support 12 (e.g., to the blade mounting portion of the blade support). The one or more cutting members 10a, 10b of the razor head (e.g., when the razor head comprises more than one cutting member) can be of the same type (e.g., all cutting members may be bent blades) or can be of different types in the above-defined sense.

As the user glides the shaver head 1 on the area that is being shaved (e.g., the user's face), the blade 11 exert a force on the hair that is being cut, which in turn causes the blade 11 to vibrate for a short period of time before they reach the next hair follicle (this is partially due to the force that each hair is applying against the blade before it is cut). Due to the design of the shaver head 1, any vibrations on the blade 11 are directly transferred to the resilient element which in turn may be transduced into the electric signal.

In an embodiment, the at least one resilient element of the one or more resilient elements (20a, 20b) may comprise a piezoelectric element or tellurium nanowires. As the at least one resilient element deforms due to the force each hair is applying to the respective cutting member of the one or more cutting members 10a, 10b to which the at least one resilient element is connected, the piezoelectric element or the tellurium nanowires may allow transducing the mechanical deformation of the resilient element into the electrical signal corresponding to the vibration of the respective cutting member. For example, the piezoelectric element may comprise a piezoelectric ceramic material or a piezoelectric polymer. In a non-exhaustive example, the piezoelectric ceramic material may comprise one or more of a lead zirconate titanate (PZT) material, barium titanate (BT) material, and strontium titanate (ST) material.

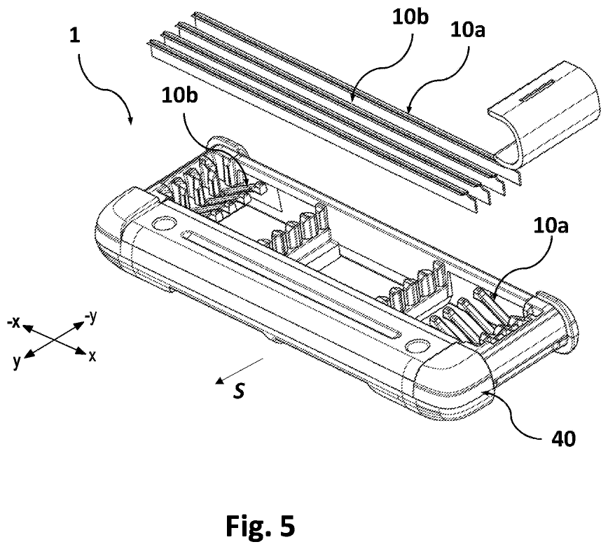

FIG. 5 schematically illustrates a perspective partial exploded view of a razor head 1.

In an example, the razor head 1 may further comprise a housing 40 extending longitudinally along the longitudinal axis x, wherein the housing 40 may comprise the leading longitudinal side 41, the trailing longitudinal side 42, and the recess in between the leading and trailing longitudinal sides for accommodating the one or more cutting members 10a, 10b, wherein the one or more cutting members 10a, 10b are disposed at least partially in the recess, wherein a cutting member of the one or more cutting members 10a, 10b is arranged between the leading longitudinal side 41 and the trailing longitudinal side 42 of the recess in the shaving direction S of the razor head 1. In an example, the one or more cutting members 10a, 10b are supported on the one or more resilient elements 20a, 20b in such a way that vibrations of the one or more cutting members 10a, 10b are transmitted to the resilient elements while the razor head 1 is used for shaving by the user.

According to a second aspect, the shaving razor assembly 70 may comprise the razor head 1, a razor handle 50, wherein the razor head 1 may be either releasably attached to the razor handle 50 or integrally formed with the razor handle 50. In an example the razor head 1 may be releasably attached to the razor handle or integrally formed with the razor handle 50 via a non-pivotable connection, or via a pivotable connection.

In an embodiment, the razor handle 50 may comprise an electronic circuitry 64, and the at least one resilient element of the one or more resilient elements 20a, 20b that is configured to transduce vibrations from the one or more cutting members 10a, 10b into an electrical signal corresponding to the vibrations from the one or more cutting members 10a, 10b is electrically connected to the electronic circuitry 64, wherein the electronic circuitry 64 is configured to receive the electrical signal. In an example, to electrically connect the resilient elements to the electronic circuitry 64, the razor head 1 may comprise a plurality of first electrical connectors and the razor handle 50 may further comprise a plurality of second electrical connectors, wherein the plurality of first electrical connectors and the plurality of second electrical connectors are configured to electrically connect the at least one resilient element of the one or more resilient elements 20a, 20b that is configured to transduce vibrations from the one or more cutting members 10a, 10b into an electrical signal corresponding to the vibrations from the one or more cutting members 10a, 10b to the electronic circuitry 64. In an example, the plurality of first electrical connectors and the plurality of second electrical connectors may comprise a pogo pin system, contacting (copper) pads, or any other suitable plug and socket system.

In an example, the razor head 1 may comprise one or more electrically conductive elements 30a, 30b comprising at least one of conductive polymer, copper wires, or aluminum wires to electrically connect the at least one resilient element of the one or more resilient elements 20a, 20b to the plurality of first electrical connectors. In embodiments of the razor head 1, conductive polymers may be used in the injection molding process of the razor head 1 that may be designed such that the conductive polymers serve as wires.

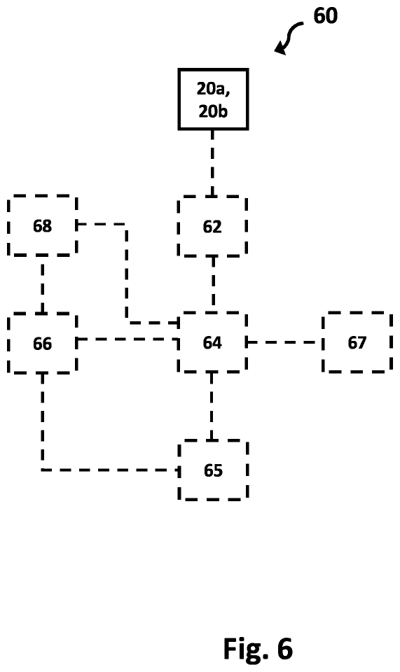

FIG. 6 schematically illustrates a functional interconnection of the shaving razor assembly components.

In an embodiment, the shaving razor assembly 60 may comprise a feedback generator 65 configured to receive a feedback signal based on the electrical signal corresponding to the vibrations of the at least one resilient element of the one or more resilient elements 20a, 20b from the electronic circuitry 64 and configured to transduce the electrical energy of the feedback signal into mechanical energy configured to be sensed by the user. The electronic circuitry 64 may be configured to receive the electrical signal from the at least one resilient element as shown in FIG. 6 and may be configured to amplify, to convert, and/or to process the electrical signal in another suitable way to output a feedback signal corresponding to the vibrations of the at least one resilient element to the feedback generator 65. In an example, the electronic circuitry 64 may comprise analog signal capture electronics 62 (FIG. 6) configured to receive the electrical signal corresponding to the vibrations from the at least one resilient element, digitize the electrical signal and to output the digitized electrical signal. In an example, the electronic circuitry 64 may comprise a processor or other suitable electronics to process the digitized electrical signal. In an example, the feedback signal may be an analogous signal. In an example, the feedback signal may comprise at least partially alternating portions at a predetermined frequency. The electronic circuitry 64 may comprise driver electronics configured to generate the analogous feedback signal from the digitized and processed electrical signal and to output the feedback signal. In an example, the receiving of the electrical signal and the outputting of the feedback signal may be a wholly or at least partially analog process. The feedback generator 65 is designed to transduce the electrical energy of the feedback signal into mechanical energy, such as in the form of vibrations, oscillations, or sound waves, which may lead to a feedback experience for the user. In the case of vibrations, the user may feel the vibrations at the fingers or the palm.

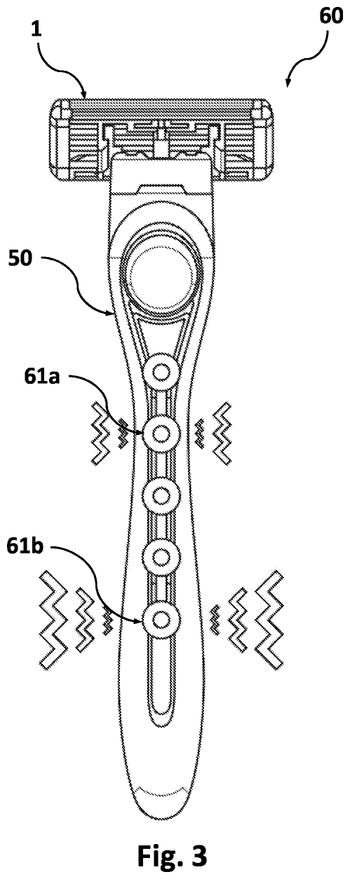

In an embodiment, the feedback generator 65 may comprise one or more transducer elements 61a, 61b, wherein the one or more transducer elements may comprise one of an ultrasonic transducer, a rotary motor with an eccentric weight, a linear vibration motor, or a piezoelectric vibration motor. The one or more transducer elements may form an array of transducer elements forming the feedback generator 65 and may be disposed in a line along a longitudinal direction of the razor handle 50 being spaced from each other as exemplarily shown in FIG. 3. In an example, the number of transducer elements of the one or more transducer elements 61a, 61b corresponds to the number of the one or more cutting members 10a, 10b.

In an embodiment, at least one transducer element of the one or more transducer elements 61a, 61b of the feedback generator 65 may correspond to one cutting member of the one or more cutting members 10a, 10b and may receive an individual feedback signal based on the electrical signal corresponding to the vibrations of the at least one resilient element connected to the respective cutting member. For example, for each cutting member, the vibration may be transduced by a respective resilient element into an electrical signal, each of which is processed separately and results in a respective feedback signal, wherein each transducer element of the one or more transducer elements 61a, 61b receives a respective feedback signal. In this case, a transducer element gives feedback to the user corresponding to the vibration of the cutting member to which the respective transducer element of the one or more transducer elements 61a, 61b is assigned. In other cases, the assignment of the one or more cutting members 10a, 10b to the one or more transducer elements 61a, 61b may be different, e.g. there may two transducers elements be assigned to one cutting member of the one or more cutting members 10a, 10b to increase the feedback effect, or the assignment can be chosen arbitrarily.

In an embodiment, the razor handle 50 may further comprise a user interface 67 electrically connected to the electronic circuitry 64 and configured to output a user input signal to the electronic circuitry 64 and/or configured to display an operating state of the razor assembly. For example, the user interface 67 may comprise a button, a rotational encoder wheel, or a linear slider. The user interface 67 may be used by the user to switch on and off the feedback generator 65 or may determine the intensity or the strength of the feedback experienced by the user. To switch off the feedback generator 65, the electronic circuitry 64 may be configured to not output a feedback signal. For example, the electronic circuitry 64 may receive the input signal and may output a feedback signal with an amplitude depending on user input. For example, an amplitude of the feedback signal may be higher when a user wants to experience stronger feedback. For example, an amplitude of the feedback signal may be lower if a user wants to experience weaker feedback. In a case when the feedback signal comprises at least partially alternating portions, the frequency of the alternating portions may be determined by the electronic circuitry 64 on the basis of the user input.

In an example, the user interface 67 may be configured to receive driving signals indicating the operating state of the shaving razor assembly from the electronic circuitry 64. In an example, the user interface 67 may comprise at least one light emitting diode configured to indicate the operating state such as e.g., the strength or intensity of the feedback, or if the feedback generator 65 is switched on or off. In an example, for a cutting member of the one or more cutting members 10a, 10b the intensity of vibration may be indicated to the user by the user interface 67. The user interface 67 may comprise a display device such as a light emitting diode display device, a liquid crystal display device, organic light emitting display device, a two-color display device or multiple-color display device, or any other suitable display device.

In an example, razor handle 50 may further comprise a touch sensor 68 configured to detect a touch of a user and to output a detection signal to the electronic circuitry 64 corresponding to the touch of the user on the razor handle 50. In an example, the touch sensor 68 comprises at least one of a capacitive sensor, a proximity sensor, a ultrasonic proximity sensor, or a time of flight sensor. For example, the electronic circuitry 64 may be configured to output a feedback signal on the basis of the detection signal. In an example, the detection signal includes information about a touching area on the razor handle 50 touched by the user. For example, the electronic circuitry 64 may be configured to decrease the amplitude of the feedback signal when the detection signal indicates that the touching area decreases, or the electronic circuitry 64 and/or the feedback generator 65 may enter a sleeping mode when the detection signal indicates that the user does not grasp/touch the handle 50. In an example, the selection which transducer element of the one or more transducer elements 61a, 61b is operated is based on the information about the touching area. For example, the electronic circuitry 64 may be configured not to output a feedback signal to a transducer element at whose position on the handle a touch of the user is not indicated by the detection signal. In an example, a transducer element of the one or more transducer elements 61a or 61b may generate stronger feedback to the user (e.g. through a feedback signal with lower amplitude and/or lower frequency) at a position at which the detection signal indicates a touch of the user than at a position at which the detection signal does not indicate a touch.

In an example, the electronic circuitry 64 may further comprise a computational system comprising at least one processor and a memory. The memory may comprise a random-access memory and/or a read-only memory. In an example, the computational system may be configured to receive at least one of the information included in the electrical signal corresponding to the vibrations, the detection signal, or the user input signal and to output at least one of the feedback signal or the driving signal indicating the operating state of the shaver razor assembly 60. As mentioned above, the processing of the electrical signal corresponding to the vibrations may be performed by the processor. The feedback signal may be generated through the processor while processing the electrical signal corresponding to the vibrations on the basis of parameters which may be stored in the memory such as a predetermined amplitude or frequency.

In an example, the electronic circuitry 64 may further comprise a communication interface configured to communicate with a computer system. The computer system may comprise a mobile device such as a smartphone or a tablet, a personal computer, or any other stationary or non-stationary data-processing device. The electronic circuitry 64 may transfer vibration information included in the electrical signal corresponding to the vibrations to the computer system or may transfer information about the input of the user included in the input signal to the computer system. For example, the information may be stored in the computer system and may be used for further analysis such as for analysing the user behaviour. The communication interface may be configured to communicate with the computer system using at least one of Bluetooth, Wireless Fidelity (WiFi), or near field communication.

In an example, the razor handle 50 may further comprise an energy storage 66 configured to provide electrical energy to the electronic circuitry 64. The energy storage 66 may comprise any kind of battery or rechargeable accumulator. The energy storage 66 may further provide electrical energy and/or the communication interface to the user interface 67 through a direct connection or through parts of the electronic circuitry 64 as exemplary shown in FIG. 6.

According to the third aspect the kit of parts comprises a razor head holder comprising a plurality of razor heads 1 in accordance with the techniques of the first aspect, or its embodiments. Further, kit of parts comprises a razor handle 50. More specifically, the kit of parts may comprise the razor handle 50 according to the second aspect as described above. The kit of parts further comprises a charging system configured to charge the energy storage 66 of the razor handle 50. In an example, the charging system may be configured to charge the energy storage 66 according to the second aspect as described above. In an example, the charging system may include a power supply that converts electrical voltage and/or electrical current from the power grid in such a way to be suitable to be supplied to the energy storage 66. The charging system may comprise electronics for smoothing and/or rectifying the electrical voltage and/or electrical current from the power grid. The charging system may be configured to be connected to the energy storage 66 by means of a wired connection e.g. with a plug and socket system to charge the energy storage 66. In an example, the charging system may be configured to charge the energy storage 66 based on inductive charging.

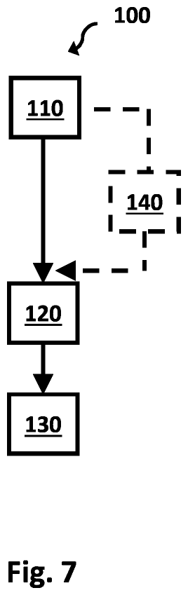

FIG. 7 schematically illustrates a computer-implemented method for generating user feedback while shaving using the shaving razor assembly 60.

According to the fourth aspect the computer-implemented method 100 for generating user feedback while shaving using a shaving razor assembly 60 in accordance with the techniques of the second aspect, or its embodiments, comprises receiving 110 an electrical signal corresponding to vibrations of one or more cutting members 10a, 10b from at least one resilient element of one or more resilient elements 20a, 20b of a razor head 1 of the shaving razor assembly 60, generating 120 a feedback signal on the basis of the electrical signal corresponding to the vibrations, and outputting 130 the feedback signal to a feedback generator 65 of the shaving razor assembly 60 configured to transduce the electrical energy of the feedback signal into mechanical energy configured to be sensed by the user. For example, the computer-implemented method 11 may be performed by a processor of the electronic circuitry 64 in accordance with the techniques of the second aspect. The computer-implemented method may be performed, at least partially, by a computer system communicating with the electronic circuitry 64 via the communication interface according to techniques of the second aspect.

In an example, the computer-implemented method 100 may further comprise after receiving 110, analyzing 130 the electrical signal corresponding to the vibrations from the at least one resilient element of the one or more resilient elements 20a, 20b of the razor head 1, and wherein when the electrical signal indicates the vibrations being below a predetermined threshold, the feedback signal may be configured to warn the user through the feedback generator 65 about skin irritation. In the event, the user is shaving an array repeatedly, the vibrations of the one or more cutting members 10a, 10b (e.g., the amplitude of the electrical signal generated by the at least one resilient element of the one or more resilient elements 20a, 20b) will be significantly smaller compared to their previous series of strokes. The electronic circuitry 64 (e.g., through the processor) will be capable of comparing the current vibration data to the previous collected vibration data and hence utilize the result of the comparison to generate 120 a feedback signal being configured to warn the user through the feedback generator 65 about skin irritation.

In an example, the feedback generator 65 may comprise one or more transducer elements 61a, 61b. The method 100 may further comprise receiving a detection signal corresponding to the touch of the user on the razor handle 50 including information about a touching area on the razor handle 50 touched by the user, and operating the one or more transducer elements 61a, 61b based on the information about a touching area on the razor handle 50 touched by the user. More specifically, the receiving of the detection signal and the operating of the one or more transducer elements 61a, 61b may be performed according to techniques of the second aspect.

In an example, the receiving 110 may comprise receiving a first electrical signal from a first resilient element and a second electrical signal from a second resilient element, wherein the first resilient element may be connected to a first cutting member of one or more cutting members 10a, 10b and the second resilient element may be connected to a second cutting member of the one or more cutting members 10a, 10b, wherein the first cutting member may be arranged in front of the second cutting member in the shaving direction S. The method 100 may further comprise comparing the first electrical signal to the second electrical signal, wherein when the first electrical signal indicates vibrations of the first cutting member being smaller than the vibrations of the second cutting member by a predetermined value, the feedback signal may be configured to warn the user about un-cut hair.

References throughout the preceding specification to “one embodiment”, “an embodiment”, “one example” or “an example”, “one aspect” or “an aspect” means that a particular feature, structure, or characteristic described in connection with the embodiment or example is included in at least one embodiment of the present disclosure. Thus, appearances of the phrases “in one embodiment”, “in an embodiment”, “one example” or “an example”, “one aspect” or “an aspect” in various places throughout this specification are not necessarily all referring to the same embodiment or example.

Furthermore, the particular features, structures, or characteristics can be combined in any suitable combinations and/or sub-combinations in one or more embodiments or examples.

### Embodiments

1. A razor head 1, comprising:
one or more cutting members 10a, 10b;
one or more resilient elements 20a, 20b, wherein a resilient element of the one or more resilient elements 20a, 20b is connected with a respective cutting member from the one or more cutting members 10a, 10b and wherein at least one resilient element of the one or more resilient elements 20a, 20b is configured to transduce vibrations from the respective cutting member of the one or more cutting members 10a, 10b into an electrical signal corresponding to the vibrations when the razor head 1 is used by a user.
   2. The razor head 1 according to embodiment 1, wherein the at least one resilient element of the one or more resilient elements 20a, 20b comprises a piezoelectric element or tellurium nanowires.
   3. The razor head 1 according to embodiment 1 or 2, wherein the resilient element of the one or more resilient elements 20a, 20b is one of a spring, a beam, and a slab.
   4. The razor head 1 according to embodiment 1, 2, or 3, wherein the razor head 1 extends longitudinally along a longitudinal axis x and the resilient element is disposed on a first side of the longitudinal extension along the longitudinal axis x of the razor head 1 and extends from the first side towards the respective cutting member from the one or more cutting members 10a, 10b along a first direction d, wherein the longitudinal axis x forms a predetermined angle with respect to the first direction d.
   5. The razor head 1 according to embodiment 4, wherein a number of resilient elements of the one or more resilient elements 20a, 20b is at least two, and wherein a second resilient element 20b of the one or more resilient elements 20a, 20b is disposed on a second side of the longitudinal extension along the longitudinal axis x of the razor head 1 that is opposite the first side.
   6. The razor head 1 according to any one of the preceding embodiments, wherein the cutting member of the one or more cutting members 10a, 10b is an integrally formed cutting member comprising a radiused bend, and a cutting edge formed at a distal end of the radiused bend, or wherein the cutting member of the one or more cutting members 10a, 10b comprises a blade 11 attached to the cutting member.
   7. The razor head 1 according to any one of the preceding embodiments, further comprising:
a housing 40 extending longitudinally along a longitudinal axis x,
wherein the housing 40 comprises a leading longitudinal side 41, a trailing longitudinal side 42, and a recess in between the leading and trailing longitudinal sides for accommodating the one or more cutting members 10a, 10b,
wherein the one or more cutting members 10a, 10b are disposed at least partially in the recess,
wherein a cutting member of the one or more cutting members 10a, 10b is arranged between a leading longitudinal side 41 and the trailing longitudinal side 42 of the recess in a shaving direction S of the razor head 1.
   8. A shaving razor assembly 60, comprising:
a razor head 1 according to any one of embodiments 1 to 7:
a razor handle 50,
wherein the razor head 1 is either releasably attached to the razor handle 50 or integrally formed with the razor handle 50
   9. The shaving razor assembly 60 according to embodiment 8, wherein the razor handle 50 comprises an electronic circuitry 64, and the at least one resilient element of the one or more resilient elements 20a, 20b that is configured to transduce vibrations from the one or more cutting members 10a, 10b into an electrical signal corresponding to the vibrations from the one or more cutting members 10a, 10b is electrically connected to the electronic circuitry 64, wherein the electronic circuitry 64 64 is configured to receive the electrical signal.
   10. The shaving razor assembly 60 according to embodiment 8 or 9, the razor head 1 comprising a plurality of first electrical connectors and the razor handle 50 further comprising a plurality of second electrical connectors, wherein the plurality of first electrical connectors and the plurality of second electrical connectors are configured to electrically connect the at least one resilient element of the one or more resilient elements 20a, 20b that is configured to transduce vibrations from the one or more cutting members 10a, 10b into an electrical signal corresponding to the vibrations from the one or more cutting members 10a, 10b to the electronic circuitry 64.
   11. The shaving razor assembly 60 according to embodiment 10, wherein the razor head 1 comprises one or more electrically conductive elements 30a, 30b comprising at least one of conductive polymer, copper wires, or aluminum wires to electrically connect the at least one resilient element of the one or more resilient elements 20a, 20b to the plurality of first electrical connectors.
   12. The shaving razor assembly 60 according to any one of embodiments 9 to 11, further comprising a feedback generator 65 configured to receive a feedback signal based on the electrical signal corresponding to the vibrations of the at least one resilient element of the one or more resilient elements 20a, 20b from the electronic circuitry 64 and configured to transduce the electrical energy of the feedback signal into mechanical energy configured to be sensed by the user.
   13. The shaving razor assembly 60 according to any one of embodiments 9 to 12, wherein the electronic circuitry 64 further comprises analog signal capture electronics 62 configured to receive the electrical signal corresponding to the vibrations from the at least one resilient element, digitize the electrical signal and to output the digitized electrical signal.
   14. The shaving razor assembly 60 according to embodiment 13, wherein the feedback generator 65 comprises one or more transducer elements 61a, 61b, wherein the one or more transducer elements 61a, 61b comprises one of an ultrasonic transducer, a rotary motor with an eccentric weight, a linear vibration motor, or a piezoelectric vibration motor.
   15. The shaving razor assembly 60 according to embodiment 14, wherein the number of transducer elements of the one or more transducer elements 61a, 61b corresponds to the number of the one or more cutting members 10a, 10b.
   16. The shaving razor assembly 60 according to embodiment 14 or 15, wherein at least one transducer element of the one or more transducer elements 61a, 61b of the feedback generator 65 corresponds to one cutting member of the one or more cutting members 10a, 10b and receives an individual feedback signal based on the electrical signal corresponding to the vibrations of the at least one resilient element connected to the respective cutting member.
   17. The shaving razor assembly 60 according to any one of embodiments 9 to 16, the razor handle 50 further comprising a user interface 67 electrically connected to the electronic circuitry 64 and configured to output a user input signal to the electronic circuitry 64 and/or configured to display an operating state of the shaving razor assembly 60.
   18. The shaving razor assembly 60 according to embodiment 17, wherein the user interface 67 comprises a button, a rotational encoder wheel, or a linear slider.
   19. The shaving razor assembly 60 according to embodiment 17 or 18, wherein the user interface 67 is configured to receive driving signals indicating the operating state of the shaving razor assembly from the electronic circuitry 64.
   20. The shaving razor assembly 60 according to embodiment 17, 18, or 19, wherein the user interface 67 comprises at least one light emitting diode.
   21. The shaving razor assembly 60 according to any one of embodiments 9 to 20, razor handle 50 further comprising a touch sensor 68 configured to detect a touch of a user and to output a detection signal to the electronic circuitry 64 corresponding to the touch of the user on the razor handle 50.
   22. The shaving razor assembly 60 according to embodiment 21, wherein the touch sensor 68 comprises at least one of a capacitive sensor, a proximity sensor, a ultrasonic proximity sensor, or a time of flight sensor.
   23. The shaving razor assembly 60 according to embodiment 20, 21 or 22, wherein the detection signal includes information about a touching area on the razor handle 50 touched by the user.
   24. The shaving razor assembly 60 according to embodiment 23, wherein the selection which transducer element of the one or more transducer elements 61a, 61b is operated is based on the information about the touching area.
   25. The shaving razor assembly 60 according to any one of embodiments 9 to 24, the electronic circuitry 64 further comprising a computational system comprising at least one processor and a memory.
   26. The shaving razor assembly 60 according to embodiment 25, wherein the memory comprises a random-access memory and/or a read-only memory.
   27. The shaving razor assembly 60 according to embodiment 25 or 26, wherein the computational system is configured to receive at least one of the information included in the electrical signal corresponding to the vibrations, the detection signal, or the user input signal and to output at least one of the feedback signal or the driving signal indicating the operating state of the shaver razor assembly.
   28. The shaving razor assembly 60 according to any one of embodiments 9 to 27, the electronic circuitry 64 further comprising a communication interface configured to communicate with a computer system.
   29. The shaving razor assembly 60 according to embodiment 28, wherein the communication interface is configured to communicate with the computer system using at least one of Bluetooth, Wireless Fidelity (WiFi), or near field communication.
   30. The shaving razor assembly 60 according to any one of embodiments 9 to 29, the razor handle 50 further comprising an energy storage 66 configured to provide electrical energy to the electronic circuitry 64.
   31. A kit of parts comprising:
a razor head holder comprising a plurality of razor heads 1 according to any one of embodiments 1 to 7, a razor handle 50, and
a charging system configured to charge the energy storage 66 of the razor handle 50.
   32. The kit of parts according to embodiment 31, wherein the charging system is configured to charge the energy storage 66 based on inductive charging.
   33. A computer-implemented method 100 for generating user feedback while shaving using a shaving razor assembly 60 according to any one of embodiments 8 to 30, comprising
receiving 110 an electrical signal corresponding to vibrations of one or more cutting members 10a, 10b from at least one resilient element of one or more resilient elements 20a, 20b of a razor head 1 of the shaving razor assembly 60,
generating 120 a feedback signal on the basis of the electrical signal corresponding to the vibrations, and
outputting 130 the feedback signal to a feedback generator 65 of the shaving razor assembly 60 configured to transduce the electrical energy of the feedback signal into mechanical energy configured to be sensed by the user.
   34. The computer-implemented method 100 according to embodiment 33, further comprising after receiving 110,
analyzing 140 the electrical signal corresponding to the vibrations from the at least one resilient element of the one or more resilient elements 20a, 20b of the razor head 1, and
wherein when the electrical signal indicates the vibrations being below a predetermined threshold, the feedback signal is configured to warn the user through the feedback generator 65 about skin irritation.
   35. The computer-implemented method 100 according to embodiment 33 or 34, wherein the feedback generator 65 comprises one or more transducer elements 61a, 61b and wherein the method further comprises
receiving a detection signal corresponding to the touch of the user on the razor handle 50 including information about a touching area on the razor handle 50 touched by the user, and
operating the one or more transducer elements 61a, 61b based on the information about a touching area on the razor handle 50 touched by the user.
   36. The computer-implemented method 100 according to embodiment 33, 34, or 35, wherein receiving 110 comprises
receiving a first electrical signal from a first resilient element and a second electrical signal from a second resilient element, wherein the first resilient element is connected to a first cutting member of one or more cutting members 10a, 10b and the second resilient element is connected to a second cutting member of the one or more cutting members 10a, 10b, wherein the first cutting member is arranged in front of the second cutting member in the shaving direction S, and
comparing the first electrical signal to the second electrical signal,
wherein when the first electrical signal indicates vibrations of the first cutting member being smaller than the vibrations of the second cutting member by a predetermined value,
the feedback signal is configured to warn the user about un-cut hair.

1. A razor head, comprising:
one or more cutting members;
one or more resilient elements, wherein a resilient element of the one or more resilient elements is connected with a respective cutting member from the one or more cutting members and wherein at least one resilient element of the one or more resilient elements is configured to transduce vibrations from the respective cutting member of the one or more cutting members into an electrical signal corresponding to the vibrations when the razor head is used by a user.

2. A razor head according to claim 1, wherein the at least one resilient element of the one or more resilient elements comprises a piezoelectric element.

3. A razor head according to claim 1, wherein the at least one resilient element of the one or more resilient elements comprises tellurium nanowires.

4. A razor head according to claim 1, wherein the razor head extends longitudinally along a longitudinal axis and the resilient element is disposed on a first side of the longitudinal extension along the longitudinal axis of the razor head and extends from the first side towards the respective cutting member from the one or more cutting members along a first direction wherein the longitudinal axis forms a predetermined angle with respect to the first direction.

5. A razor head according to claim 1, wherein a number of resilient elements of the one or more resilient elements is at least two, and wherein a second resilient element of the one or more resilient elements is disposed on a second side of the longitudinal extension along the longitudinal axis of the razor head that is opposite the first side.

6. The razor head according to claim 1, wherein the cutting member of the one or more cutting members is an integrally formed cutting member comprising a radiused bend, and a cutting edge formed at a distal end of the radiused bend, or wherein the cutting member of the one or more cutting members comprises a blade attached to the cutting member.

7. A razor head according to claim 1, further comprising:
a housing extending longitudinally along a longitudinal axis,
wherein the housing comprises a leading longitudinal side, a trailing longitudinal side, and a recess in between the leading and trailing longitudinal sides for accommodating the one or more cutting members,
wherein the one or more cutting members are disposed at least partially in the recess,
wherein a cutting member of the one or more cutting members is arranged between a leading longitudinal side and a trailing longitudinal side of the recess in a shaving direction of the razor head.

8. A shaving razor assembly, comprising:
a razor head according to claim 1,
a razor handle,
wherein the razor head is either releasably attached to the razor handle or integrally formed with the razor handle.

9. A shaving razor assembly according to claim 8, wherein the razor handle comprises an electronic circuitry, and the at least one resilient element of the one or more resilient elements that is configured to transduce vibrations from the one or more cutting members into an electrical signal corresponding to the vibrations from the one or more cutting members is electrically connected to the electronic circuitry, wherein the electronic circuitry is configured to receive the electrical signal.

10. A shaving razor assembly according to claim 9, further comprising a feedback generator configured to receive a feedback signal based on the electrical signal corresponding to the vibrations of the at least one resilient element of the one or more resilient elements from the electronic circuitry and configured to transduce the electrical energy of the feedback signal into mechanical energy configured to be sensed by the user.

11. A shaving razor assembly according to claim 10, wherein the feedback generator comprises one or more transducer elements, wherein the one or more transducer elements comprises one of an ultrasonic transducer, a rotary motor with an eccentric weight, a linear vibration motor, or a piezoelectric vibration motor.

12. A shaving razor assembly according to claim 11, wherein at least one transducer element of the one or more transducer elements of the feedback generator corresponds to one cutting member of the one or more cutting members and receives an individual feedback signal based on the electrical signal corresponding to the vibrations of the at least one resilient element connected to the respective cutting member.

13. A shaving razor assembly according to claim 9, the razor handle further comprising a user interface electrically connected to the electronic circuitry and configured to output a user input signal to the electronic circuitry and/or configured to display an operating state of the razor assembly.

14. A shaving razor assembly according to claim 9, the electronic circuitry further comprising a computational system comprising at least one processor and a memory.

15. A shaving razor assembly according to claim 9, the electronic circuitry further comprising a communication interface configured to communicate with a computer system.

16. A shaving razor assembly according to claim 8, the razor handle further comprising an energy storage configured to provide electrical energy to the electronic circuitry.

17. A kit of parts comprising:
a razor head holder comprising a plurality of razor heads according to claim 1, a razor handle, and
a charging system configured to charge the energy storage of the razor handle.

18. A computer-implemented method for generating user feedback while shaving using a shaving razor assembly according to claim 8, comprising
receiving an electrical signal corresponding to vibrations of one or more cutting members from at least one resilient element of one or more resilient elements of a razor head of the shaving razor assembly,
generating a feedback signal on the basis of the electrical signal corresponding to the vibrations, and
outputting the feedback signal to a feedback generator of the shaving razor assembly configured to transduce the electrical energy of the feedback signal into mechanical energy configured to be sensed by the user.

19. A computer-implemented method according to claim 18, further comprising after receiving,
analyzing the electrical signal corresponding to the vibrations from the at least one resilient element of the one or more resilient elements of the razor head, and
wherein when the electrical signal indicates the vibrations being below a predetermined threshold, the feedback signal is configured to warn the user through the feedback generator about skin irritation.

20. A computer-implemented method according to claim 18, wherein receiving an electrical signal corresponding to vibrations of one or more cutting members comprises
receiving a first electrical signal from a first resilient element and a second electrical signal from a second resilient element, wherein the first resilient element is connected to a first cutting member of one or more cutting members and the second resilient element is connected to a second cutting member of the one or more cutting members, wherein the first cutting member is arranged in front of the second cutting member in the shaving direction, and
comparing the first electrical signal to the second electrical signal,
wherein when the first electrical signal indicates vibrations of the first cutting member being smaller than the vibrations of the second cutting member by a predetermined value,
the feedback signal is configured to warn the user about un-cut hair.
